(19) United States
(12) Patent Application Publication
(10) Pub. No.: US 2012/0211311 A1
(43) Pub. Date: Aug. 23, 2012

(54) ELEVATOR SYSTEM WITH MAGNETIC BRAKING DEVICE

(76) Inventors: Zbigniew Piech, Cheshire, CT (US); Harold Terry, Avon, CT (US)

(21) Appl. No.: 13/504,494

(22) PCT Filed: Dec. 22, 2009
(86) PCT No.: PCT/US2009/069134

§ 371 Date: Apr. 27, 2012

(51) Int. Cl. B66B 5/16; B66B 1/32

(52) U.S. Cl. 187/351

(57) ABSTRACT

An exemplary elevator system includes an elevator car situated for movement along at least one guide rail. A braking device is supported for movement with the elevator car. The braking device includes a plurality of magnet members and a plurality of cooperating members. The cooperating members are selectively movable between first and second positions relative to the magnet members. In the first position the elevator car is allowed to move along the guide rail. In the second position the magnet members and the cooperating members cooperate to cause an electromagnetic interaction between the braking device and the guide rail to resist movement of the elevator car along the guide rail.

### BACKGROUND

Elevator systems include various devices used for controlling the speed of movement of the elevator car. The elevator machine operates responsive to a controller that dictates the speed of movement of the car. An elevator machine brake applies a braking force at the machine location to decelerate the car and hold it steady at a landing, for example. Additional braking devices are provided on an elevator car.

Under some conditions, the elevator car may move at a speed that is beyond a desired limit. Under such overspeed conditions, braking devices on the car are activated to bring the car to a stop. Such braking devices typically include a friction pad that engages the guide rail along which the elevator car travels. One drawback associated with such braking devices is that the engagement between the friction pad and the guide rail tends to cause surface deformation along the corresponding portion of the guide rail. Any variations in the surface of the guide rail tends to introduce vibration and potential noise during subsequent elevator runs, which reduces the ride quality.

### SUMMARY

An exemplary elevator system includes an elevator car situated for movement along at least one guide rail. At least one braking device is supported for movement with the elevator car. The braking device includes a plurality of magnet members and a plurality of cooperating members. The cooperating members are selectively movable between first and second positions relative to the magnet members. In the first position the elevator car is allowed to move along the guide rail. In the second position the magnet members and the cooperating members cooperate to cause an electromagnetic interaction between the braking device and the guide rail to resist movement of the elevator car along the guide rail.

The various features and advantages of the disclosed example embodiments will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system designed according to an embodiment of this invention.

FIG. 2 diagrammatically illustrates an example braking device configuration.

FIG. 3 is an end view diagrammatically illustrating an example braking device embodiment.

FIGS. 4A and 4B schematically illustrate an example braking device in two different operating conditions.

FIGS. 5A and 5B schematically illustrate another example braking device in two operating conditions.

FIGS. 6A and 6B schematically illustrate another braking device arrangement in two operating conditions.

FIGS. 7A, 7B and 7C schematically illustrate another example braking device arrangement.

FIG. 8 schematically illustrates another example braking device arrangement.

FIG. 9 schematically illustrates another example braking device arrangement.

### DETAILED DESCRIPTION

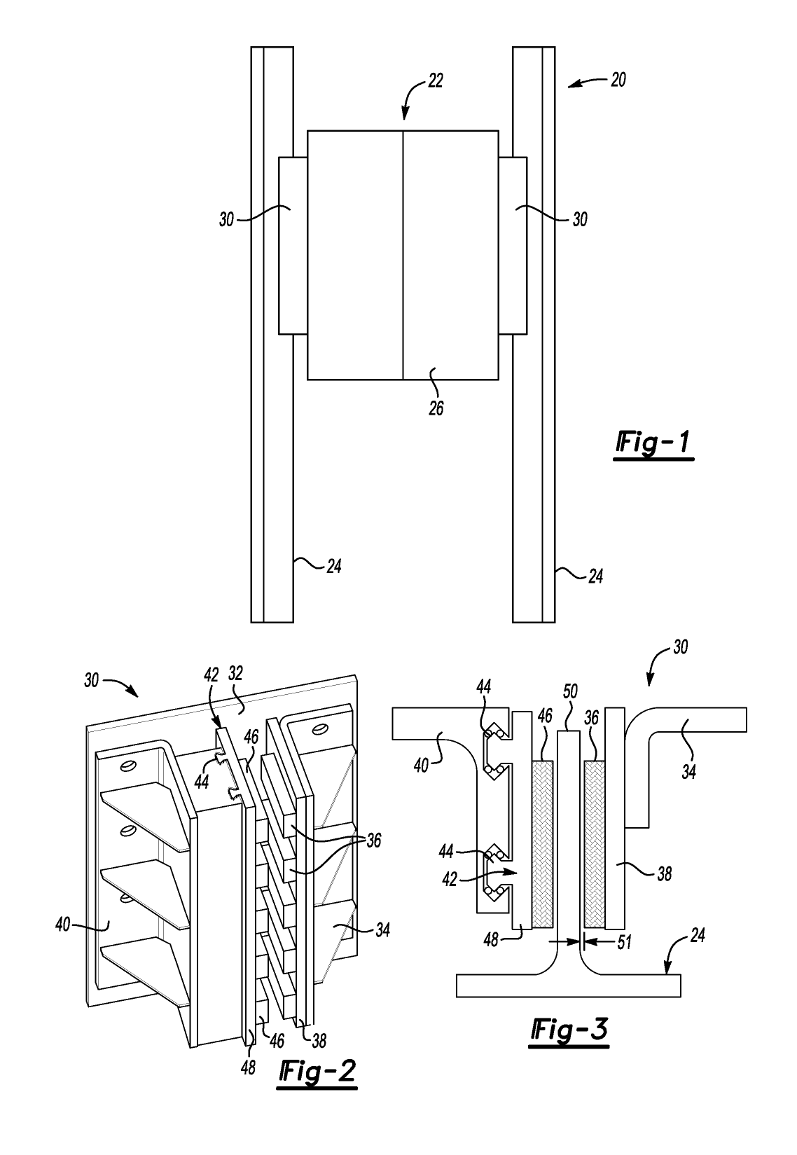

FIG. 1 schematically illustrates selected portions of an example elevator system 20. An elevator car assembly 22 is situated for movement along guide rails 24. The car assembly 22 includes an elevator car 26 and braking devices 30 that are supported for movement with the elevator car 26 along the guide rails 24. The braking devices 30 utilize electromagnetic responses in the guide rails 24 for applying a braking force to resist movement of the elevator car 26 along the guide rails 24.

FIG. 2 shows one example braking device 30 that includes a mounting plate 32 that is secured to an appropriate portion of the elevator car 26 such as the car frame. A first support bracket 34 is secured to the mounting plate 32. A plurality of magnet members 36 are supported on a first backing plate 38 that is secured to the bracket 34. In one example, the magnet members 36 comprise permanent magnets and the backing plate 38 comprises iron or another ferromagnetic material.

Another bracket 40 supports a slider 42 that is selectively movable relative to the bracket 40. In this example, linear bearings 44 are provided to facilitate linear movement of the slider 42 relative to the bracket 40 in a direction parallel to the vertical path followed by the elevator car. A plurality of cooperating members 46 are supported on a second backing plate 48, which is connected to the slider 42. The cooperating members 46 are selectively movable relative to the magnet members 36 as the slider 42 moves linearly relative to the bracket 40.

As can be appreciated from FIG. 3, for example, the guide rails 24 each include a fin 50 that is received between the magnet members 36 and the cooperating members 46 such that there is a clearance 51 between them. In this orientation the braking devices 30 are able to move along the guide rails 24 without making any contact with the surfaces on the fin 50.

When the cooperating members 46 are in a first position relative to the magnet members 36, the braking device 30 is in an inactive state when it is not being used to apply a braking force. In other words, when the cooperating members 46 are in a first position relative to the magnet members 36, the elevator car 26 is allowed to move along the guide rails 24.

When the cooperating members 46 are moved into a second position relative to the magnet members 36, the magnet members 36 and cooperating members 46 cooperate to cause an electromagnetic interaction between the guide rail and the braking device to resist movement of the elevator car along the guide rail. The electromagnetic response in the guide rail 24 results in an electrodynamic braking force that resists movement of the elevator car 26 along the guide rails 24. In one example, the electromagnetic response comprises eddy currents that are induced in the fin 50 of the guide rail 24.

The guide rail 24 comprises an electrically conductive material to facilitate application of a braking force by the braking devices 30. In one example, the guide rail 24 comprises aluminum. One feature of using aluminum for a guide rail is that it allows for a lighter weight material (e.g., aluminum is lighter than steel), which provides savings during installation compared to traditional elevator arrangements. Lighter rails facilitate less expensive installation. A softer material such as aluminum can be used in such an arrangement because there is no frictional engagement required between the braking devices 30 and the guide rail surfaces for purposes of resisting movement of the elevator car 26 under selected conditions. If frictional forces will be used, the aluminum rail may include hardened surfaces for durability.

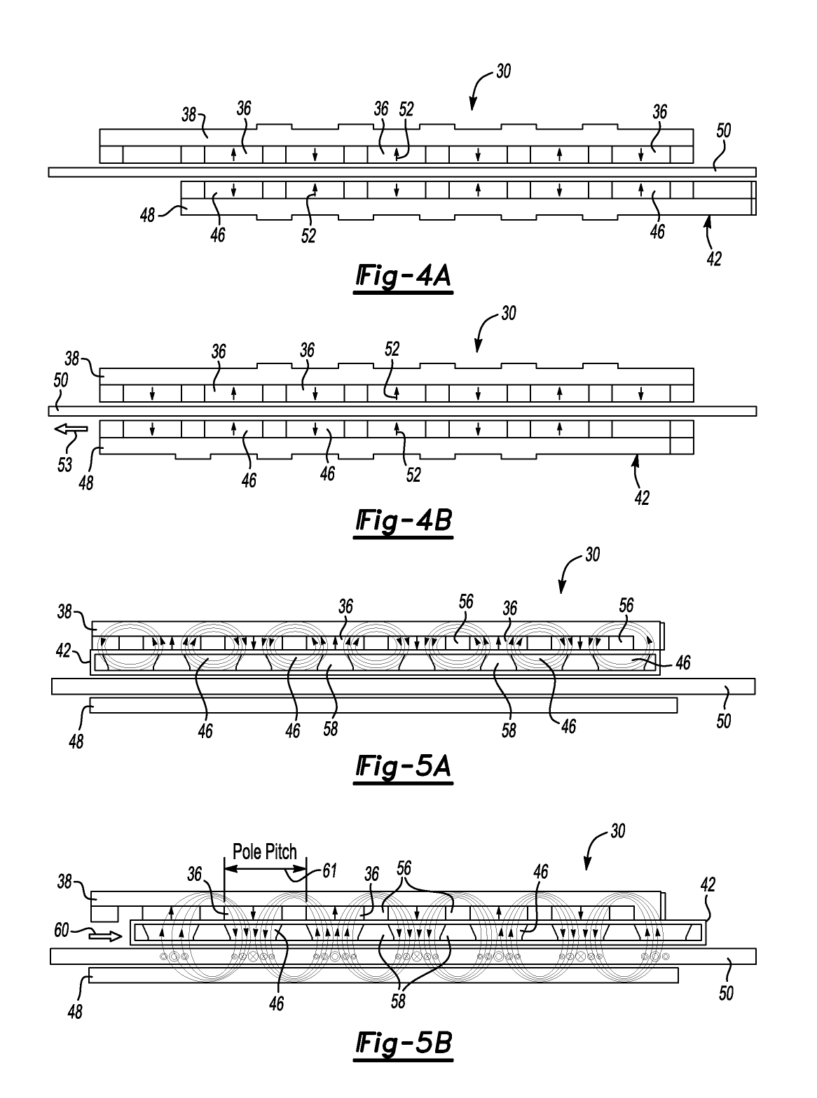

FIG. 4A schematically illustrates one example arrangement of a braking device 30. In this example, the plurality of magnet members 36 are all arranged on one side of the fin 50 of the guide rail 24. The cooperating members 46 in this example comprise permanent magnets. The rail fin 50 is positioned in a gap between the magnet members 36 and the permanent magnet cooperating members 46. The direction of magnetization or polarization of the magnets in FIG. 4A are opposite to each other on opposite sides of the rail fin 50. This is schematically shown by the arrows 52. The first position of the cooperating members 46 shown in FIG. 4A corresponds to an inactive state of the braking device 30 when the elevator car 26 is allowed to move along the guide rails 24.

FIG. 4B schematically shows the example of FIG. 4A in an active state. The active, brake-applying state is useful during an elevator overspeed condition, for example. The slider 42 and the cooperating members 46 have moved as schematically shown by the arrow 53 (i.e., to the left according to the drawing). In the second position shown in FIG. 4B the permanent magnet cooperating members 46 have a direction of magnetization that is aligned with that of the magnet members 36 directly across the rail fin 50. In this position, an electromagnetic interaction between the guide rail 24 and the braking device 30 results in a braking force that resists movement of the elevator car 26. In the second position of FIG. 4B, the magnet assemblies are positioned relative to each other so that their aligned polarizations force a flow of magnetic field across the gap between them through the guide rail fin 50. The penetrating magnetic field excites eddy currents in the rail resulting in high electrodynamic braking forces. The manner in which eddy currents excited in a rail produce electrodynamic braking forces is known.

By selectively controlling when the slider 42 and the cooperating members 46 move into the second position shown in FIG. 4B, the braking device 30 selectively applies a braking force to resist movement of the elevator car 26.

One feature of the example shown in FIGS. 4A and 4B is that even in the inactive state when the cooperating members 46 are in the first position shown in FIG. 4A, a small portion of the magnetic fields (e.g., a leakage field) will penetrate the rail fin 50 and result in a relatively small drag force during an elevator run. Such a drag force may be on the order of about three percent of the forces associated with resisting movement of the elevator car when the cooperating members 46 are in the second position. This small drag force is useful as a damping force to minimize vertical vibrations of the elevator car 26. Additionally, the leakage field that penetrates the rail when the cooperating members 46 are in the first position provides a laterally stabilizing or centering force during an elevator run. In other words, the arrangement schematically shown in FIGS. 4A and 4B provides vibration reduction features that improve elevator ride quality even though the braking devices 30 are not being used to decelerate the elevator car.

FIGS. 5A and 5B schematically show another example braking device 30. In this example, the cooperating members 46 comprise pole shoes made of a ferromagnetic material. The slider 42 and the pole shoe cooperating members 46 are on the same side of the rail fin 50 as the magnet members 36. In this example, a return iron backing plate 48 is provided on an opposite side of the rail fin 50.

When the pole shoe cooperating members 46 are in the first position shown in FIG. 5A, the magnetic field of the magnet members 36 is essentially contained on one side of the rail fin 50. In this first position, the pole shoe cooperating members 46 are at least partially aligned with a spacing 56 between the magnet members 36. This example also includes a spacing 58 between the pole shoe cooperating members 46.

As shown in FIG. 5B, the slider 42 is movable as schematically shown by the arrow 60 to place the pole shoe cooperating members 46 into a second position relative to the magnet members 36. In this position, the pole shoe cooperating members 46 are aligned with the magnet members 36, allowing the magnetic field to penetrate the rail fin 50 in a manner that excites eddy currents in the rail fin 50 to produce high enough electrodynamic forces to resist movement of the elevator car 26. In the position shown in FIG. 5B, the magnetic field of the magnets flows across the rail fin 50 from the magnet members 36 to the iron backing plate 48 on the opposite side of the rail fin 50 and back to the magnet members 36.

By selectively controlling the position of the slider 42 and the pole shoe cooperating members 46, the braking device 30 selectively applies a braking force for resisting movement of the elevator car 26. In the illustrated example, the magnet members 36 each have a width. The spacing 56 between the magnet members 36 and the width of each magnet member 36 together establish a pole pitch 61. The dimensions of the cooperating members 46 and the spacings 58 between them are selected so that the spaces 58 are aligned with the spaces 56 and the pole shoe cooperating members 46 are aligned with the magnet members 36 in the second position shown in FIG. 5B. The slider 42 moves a distance corresponding to one-half the pole pitch 61 between the first position shown in FIG. 5A and the second position shown in FIG. 5B.

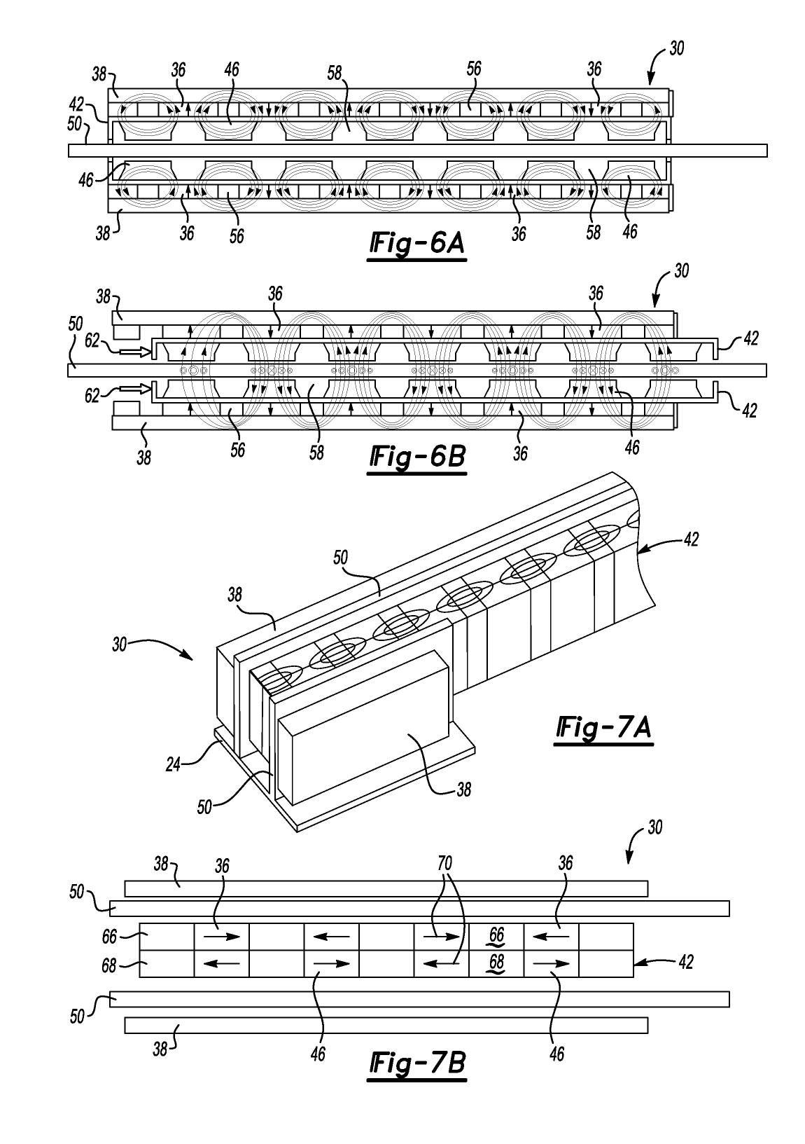

FIGS. 6A and 6B show another example arrangement in which magnet members 36 are provided on both sides of the rail fin 50 and the pole shoe cooperating members 46 are associated with each set of magnet members 36. In the first position shown in FIG. 6A, the magnetic fields of the magnet members 36 do not penetrate the rail fin 50. In the second position shown in FIG. 6B after the cooperating members 46 have moved linearly as schematically shown by the arrows 62, the magnetic fields of the magnet members 36 penetrate the rail fin 50 in a manner that excites eddy currents in the rail fin 50 to produce an electrodynamic braking force.

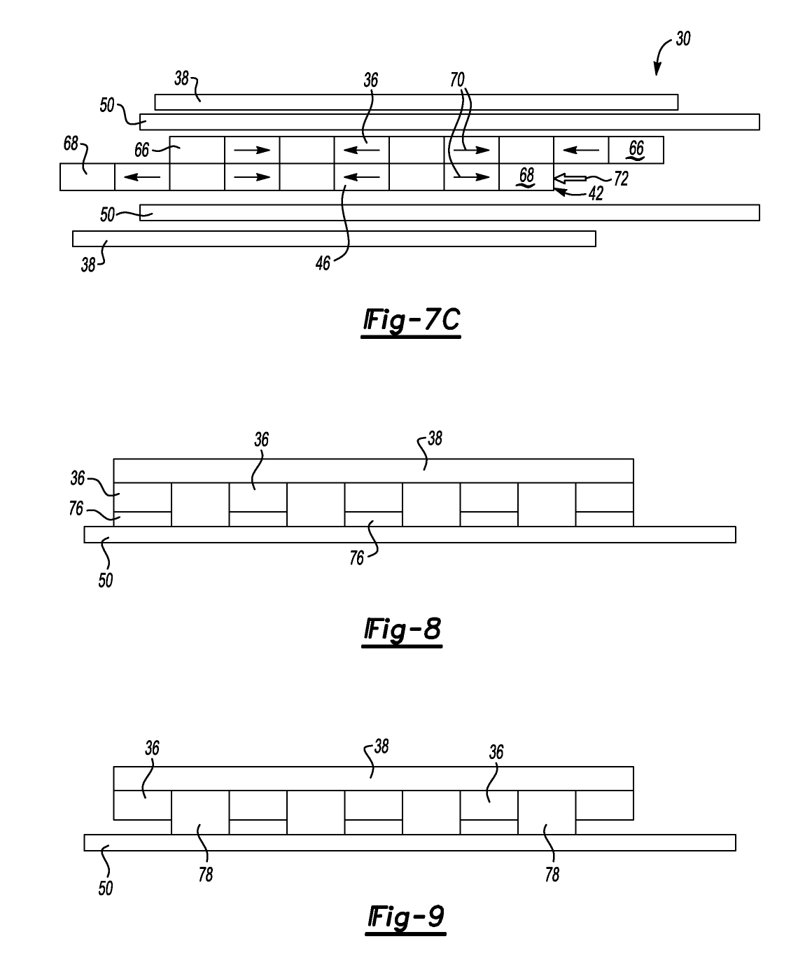

FIGS. 7A-7C schematically illustrate another example embodiment. The guide rails 24 in this example include two rail fin portions 50 and the braking device 30 is arranged to interact with both of them. Utilizing two rail fins 50 increases the surface area of conductive material within which the eddy currents can be induced. The configuration including two rail fins 50 also decreases the resistance along the eddy current path. One feature of such an arrangement is that it allows for reducing the dimension of the rail fins 50 in a direction extending away from a hoistway wall toward the center of the elevator car 26. Reducing the size of rail fin that is required allows for increasing the amount of available space for the elevator car within a hoistway or decreasing the amount of hoistway space that is required for a particular elevator car capacity, for example.

FIG. 7B shows the cooperating members 46 in a first position relative to the magnet members 36. In this example, the slider 42, the cooperating members 46 and the magnet members 36 are all positioned in the spacing between the two rail fins 50. Return iron backing plates 38 are provided on the opposite sides of each rail fin 50. In this example, the cooperating members 46 comprise permanent magnets. The magnet members 36 are spaced apart with pole pieces 66 between them. The permanent magnet cooperating members 46 are spaced apart with pole pieces 68 between them. The direction of magnetization or the polarization of the magnet members 36 and the immediately adjacent or aligned magnet cooperating members 46 in the arrangement of FIG. 7B are set so that they are in opposite directions as schematically shown by the arrows 70. In this position, essentially all of the magnetic fields of the magnet members 36 and the cooperating magnet members 46 are contained within the spacing between the two rail fins 50. This allows for the elevator car to move along the guide rails 24.

When a brake application is desired, the slider 42 shifts as schematically shown by the arrow 72 to move the magnet cooperating members 46 linearly relative to the magnet members 36 into the second position shown in FIG. 7C. In this position the direction of magnetization of the magnet members 36 and the immediately adjacent or directly aligned magnet cooperating members 46 are the same as schematically shown by the arrows 70. This orientation of the directions of magnetization and the presence of the pole members 66 and 68 between them allows for the magnetic field of the magnets to penetrate the rail fins 50 exciting eddy currents in them to produce an electrodynamic braking force.

One feature of electrodynamic braking forces as used in the above-described examples is that the amount of force is proportional to the speed with which the magnet members 36 and the cooperating members 46 are moving relative to the rail fins 50. The braking force is highest at the highest speed of movement and decreases as the elevator car 26 slows down. In some examples, the braking devices 30 will not completely stop the elevator car 26 relying only upon the electrodynamic braking forces described above. In a situation where the hoistway friction system forces are lower than the gravitational and inertia forces that would tend to propel the elevator car 24, additional friction braking may be desired to stop the elevator car at a desired location.

One example allows for applying an additional friction braking force using the structure of the braking device 30. FIG. 8 schematically shows an arrangement in which the magnet members 36 include a braking material 76 supported on the magnet members and facing the rail fin 50. Once the elevator car has been sufficiently slowed down using the electrodynamic braking forces, the backing member 38 and magnet members 36 are moved toward the rail fin 50 so that the braking material 76 contacts the rail fin 50 to provide an additional, frictional braking force to completely stop the elevator car 26.

FIG. 9 schematically shows another arrangement in which braking pads 78 are placed adjacent the magnet members 36. The braking pads 78 are selectively moved into engagement with the rail fin 50 to bring the elevator car to a complete stop under selected conditions.

In one example, moving the braking material 76 or the braking pads 78 into engagement with the rail fin 50 occurs as the result of magnetic forces between the magnet members 36 and cooperating members 46. In other words, it is possible to use magnetic attraction (or repulsion) between the various portions of example braking devices 30 to cause movement of a frictional stopping member into engagement with the rail fin 50 to prevent any movement of the elevator car.

In one example, the manner in which the magnet members 36, the cooperating members 46 or both are supported allows for material deflection so that the corresponding members move toward the rail fin 50 to eliminate clearances between the rail fin 50 and the corresponding friction braking members under selected conditions. In another example, the appropriate portion of the braking device 30 is configured to allow for lateral movement of corresponding portions of the device 30 to allow for the friction braking members to selectively engage the rail fin 50.

The preceding description is exemplary rather than limiting in nature. Variations and modifications to the disclosed examples may become apparent to those skilled in the art that do not necessarily depart from the scope of legal protection given to this invention, which can only be determined by studying the following claims.

We claim:

1. An elevator system, comprising:
an elevator car;
at least one guide rail positioned to guide movement of the elevator car; and
at least one braking device supported on the elevator car for movement with the elevator car, the braking device including a plurality of magnet members adjacent the guide rail and a plurality of cooperating members near the magnet members, the cooperating members being movable relative to the magnet members between a first position in which the braking device allows the elevator car to move along the guide rail and a second position in which the magnet members and the cooperating members cooperate to cause an electromagnetic interaction between the guide rail and the braking device to resist movement of the elevator car along the guide rail.

2. The elevator system of claim 1, wherein the magnet members and the cooperating members are all on a single side of the guide rail.

3. The elevator system of claim 1, wherein the magnet members are on one side of the guide rail and the cooperating members are on a second side of the guide rail.

4. The elevator system of claim 1, wherein the braking device comprises a base upon which the magnet members are supported and a slider upon which the cooperating members are supported for sliding between the first and second positions.

5. The elevator system of claim 1, in which the cooperating members move from the first position into the second position responsive to the elevator car moving at a speed above a selected threshold.

6. The elevator system of claim 1, wherein
the magnet members are arranged along a line with a first space between each magnet member and an adjacent magnet member;
the cooperating members are arranged along a line with a second space between each cooperating member and an adjacent cooperating member;
the first position comprises the cooperating members being at least partially aligned with the first spaces and the magnet members being at least partially aligned with the second spaces; and
the second position comprises the cooperating members being aligned with the magnet members and the first spaces being aligned with the second spaces.

7. The elevator system of claim 6, wherein the
magnet members have a width,
a distance across one of the first spaces plus the width of one of the magnets equals a first pitch, and
the cooperating members move a distance equal to one-half of the first pitch while moving from the first position to the second position.

8. The elevator system of claim 6, wherein the cooperating members move in a direction parallel to a direction of movement of the elevator car as the cooperating members move between the first and second positions.

9. The elevator system of claim 1,
the at least one guide rail comprises two parallel rail fins, and
the braking device is at least partially between the parallel rail fins such that the electromagnetic interaction is between the braking device and both of the parallel rail fins.

10. The elevator system of claim 9, wherein the magnet members and the cooperating members are disposed between the parallel rail fins.

11. The elevator system of claim 1, wherein
the magnet members are on one side of the guide rail,
the cooperating members comprise magnets on an opposite side of the guide rail,
the first position comprises the magnet members and the cooperating members aligned with each other such that a direction of magnetization of the magnet members relative to the guide rail is opposite to a direction of magnetization of the correspondingly aligned cooperating members, and
the second position comprises the magnet members and the cooperating members aligned with each other such that a direction of magnetization of the magnet members relative to the guide rail is the same as a direction of magnetization of the correspondingly aligned cooperating members.

12. The elevator system of claim 11, wherein
the direction of magnetization of each magnet member is opposite the direction of magnetization of an immediately adjacent one of the magnet members, and
the direction of magnetization of each cooperating member is opposite the direction of magnetization of an immediately adjacent one of the cooperating members.

13. The elevator system of claim 1, wherein at least some of the magnet members are movable in a direction toward the guide rail to move a braking material into engagement with the guide rail.

14. The elevator system of claim 1, comprising a friction brake member situated between at least two of the magnet members for engaging the guide rail.

15. The elevator system of claim 1, comprising a brake pad supported on a surface of at least some of the magnet members facing toward the guide rail for selectively engaging the guide rail.

16. The elevator system of claim 1, wherein the cooperating members comprise magnets.

17. The elevator system of claim 1, wherein the cooperating members comprise magnet poles.

18. A method of controlling a speed of an elevator car that has a braking device supported on the elevator car for movement with the elevator car, the braking device including a plurality of magnet members adjacent the guide rail and a plurality of cooperating members near the magnet members, the method comprising the steps of:
maintaining the cooperating members in a first position relative to the magnet members such that the braking device allows the elevator car to move along the guide rail; and
selectively moving the cooperating members into a second position in which the magnet members and the cooperating members cooperate to cause an electromagnetic interaction between the guide rail and the braking device to resist movement of the elevator car along the guide rail, when a reduction in elevator car speed is desired.

19. The method of claim 18, comprising moving the cooperating members from the first position into the second position responsive to the elevator car moving at a speed above a selected threshold.

20. The method of claim 18, comprising applying a frictional braking force subsequent to the electromagnetic interaction resulting in the elevator car moving below a selected threshold speed.
